(19) United States
(12) Patent Application Publication
(10) Pub. No.: US 2021/0277985 A1
(43) Pub. Date: Sep. 9, 2021

(54) VECTORING AXLE DRIVE

(71) Applicant: FORD GLOBAL TECHNOLOGIES, LLC, Dearborn, MI (US)

(72) Inventor: David Allen JANSON, Plymouth, MI (US)

(21) Appl. No.: 16/812,927

(22) Filed: Mar. 9, 2020

(51) Int. Cl. F16H 48/36; F16H 48/22

(52) U.S. Cl. CPC F16H 48/36; F16H 2059/503; F16H 48/22

(57) ABSTRACT

An electrical vehicle includes an electric machine and a vectoring motor that propel the vehicle. The vectoring motor drives a right axle shaft and a left axle shaft axle through a torque multiplier. First and second planetary gear sets are connected to right and left ends of a linking shaft that extends through a central opening defined by a rotor and a tubular output shaft of the motor. Torque is provided through the linking shaft to the first and second planetary gear sets. First and second grounding clutches normally lock the first and second planetary gear sets to a case of the vectoring motor. The grounding clutches are selectively and partially released to allow the ring gear of one of the first and second planetary gear sets to reduce a torque output of one of the first and second planetary gear sets to right and left axle shafts.

### TECHNICAL FIELD

This disclosure relates to a drive for a driven axle of a vehicle that provides vectoring by reducing the torque supplied to one of two axle shafts.

### BACKGROUND

Vehicles such as plug-in electric vehicles, hybrid electric vehicles, internal combustion engine vehicles, and the like have an electric machine, engine, or motor having a primary drive that provides torque to an axle to propel the vehicle.

Vectoring drives adjust the torque supplied to two axle shafts of an axle assembly when cornering to improve handling and control of the vehicle, particularly with four-wheel drive vehicles. Several approaches to vectoring have been developed but these prior solutions add to the cost of the rear axle drive because many proposed solutions require providing a second vectoring drive motor, adding a balance shaft, or adding a differential gear set. Another problem facing electric rear axle drive (ERAD) systems is that there is limited space to fit the systems under the vehicle around the rear axle.

This disclosure is directed to solving the above problems and other problems as summarized below.

### SUMMARY

According to one aspect of this disclosure, a vehicle is disclosed that includes a vectoring system. The vectoring system comprises a vectoring motor disposed in a case and connected to an axle including a right axle shaft and a left axle shaft for propelling the vehicle. The vectoring motor includes a rotor and a tubular output shaft that defines a central opening. A torque multiplying gear set receives torque from the tubular output shaft of the vectoring motor and transfers torque to a linking shaft that extends through the central opening. First and second planetary gear sets including first and second sun gears are connected to first and second ends of the linking shaft. The linking shaft provides torque to the first and second sun gears of the first and second planetary gear sets. The first and second planetary gear sets each include a plurality of planetary gears connected to a planetary gear carrier. The planetary gears are connected to first and second ring gears of the first and second planetary gear sets. The planetary gear carriers are connected to the right and left axle shafts. First and second grounding clutches normally lock the first and second ring gears to the case of the vectoring motor. The grounding clutches are selectively and partially released to allow the ring gear of one of the first and second planetary gear sets to slip relative to the case thereby reducing a torque output provided to the carrier of one of the first and second planetary gears and to one of the right and left axle shafts.

According to other aspects of this disclosure, torque may be provided equally to both right and left axle shafts when the vehicle is moving in a straight line with both ring gears locked. Torque provided to the right axle shaft is reduced by the first grounding clutch partially releasing the first ring gear and allowing the first ring gear to slip when the vehicle turns to the right. Torque provided to the left axle shaft is reduced by the second grounding clutch partially releasing the second ring gear and allowing the second ring gear to slip when the vehicle turns to the left. A controller receives data from a turning radius sensor and at least one axle speed sensor. During a turn, the controller actuates a hydraulic system connected to one of the first and second grounding clutches to partially release the ring gear of a selected one of the planetary gear sets and reduce torque output provided to a planet carrier of the planet gears of the selected one of the planetary gear sets.

According to another aspect of this disclosure, torque provided to the right axle shaft is reduced by the first grounding clutch partially releasing the first ring gear and allowing the first ring gear to slip when a right wheel slips on a surface with a low coefficient of friction. Torque provided to the left axle shaft is reduced by the second grounding clutch partially releasing the second ring gear and allowing the second ring gear to slip when a left wheel slips on a surface with a low coefficient of friction. A controller may receive data from at least one axle speed sensor, wherein the controller actuates a hydraulic system of one of the first and second grounding clutches to partially release the ring gear of a selected one of the planetary gear sets and reduce torque output provided to a planet carrier of the planet gears of the selected one of the planetary gear sets.

A hydraulic actuator may actuate the grounding clutch to selectively and partially release the ring gear to allow the ring gear to slip relative to the case. Alternatively, a brake, a static clutch, or a magnetic clutch may be used to lock up or allow the ring gears to slip.

According to another aspect of this disclosure, a vectoring drive is disclosed for a vehicle. The vectoring drive includes a case and a motor disposed in the case that includes a rotor, a tubular output shaft defining a central opening, and a stator disposed around an outer diameter of the rotor. A linking shaft extends through the central opening and a torque multiplying gear set connected to the tubular output shaft provides torque to the linking shaft. First and second planetary gear sets on right and left ends of the linking shaft have first and second sun gears, respectively, that receive torque through the linking shaft from the torque multiplying gear set. First and second grounding clutches normally lock a first ring gear of the first planetary gear set to the case and a second ring gear of the second planetary gear set to the case. Right and left axle shafts are operatively connected to first and second carriers of a first plurality of planet gears of the first planetary gear set. Torque is provided equally to both right and left axle shafts with both ring gears locked. Torque provided to the right axle shaft is reduced by the first grounding clutch partially releasing the first ring gear and selectively allowing the first ring gear to slip. Torque provided to the left axle shaft is reduced by the second grounding clutch partially releasing the second ring gear and selectively allowing the second ring gear to slip.

According to a further aspect of this disclosure, a first hydraulic actuator that engages the first grounding clutch may selectively and partially release the first ring gear to allow the first ring gear to slip relative to the case. A second hydraulic actuator that engages the second grounding clutch may selectively and partially release the second ring gear to allow the second ring gear to slip relative to the case. Other types of actuators, as noted above, may be used instead of the disclosed hydraulic actuators.

According to another aspect of this disclosure, a torque vectoring system is disclosed for a vehicle. The torque vectoring system includes a housing with a first end and a second end disposed opposite the first end and an interconnecting member rotationally supported by the housing. First and second planetary gear sets are disposed adjacent the first end and the second end of the housing. First and a second sun gears of the first and the second planetary gear sets are each fixedly joined to the interconnecting member for common rotation. First output member is fixedly joined to a first for common rotation to a first carrier member of the first planetary gear set for common rotation. Second output member is fixedly joined to a second carrier member of the second planetary gear set for common rotation. A first clutch selectively connects a first ring gear of the first planetary gear set to the housing. A second clutch selectively connects a second ring gear of the second planetary gear set to the housing. Partial release of the first clutch reduces a first torque ratio between the interconnecting member and the first output and partial release of the second clutch reduces a second torque ratio between the interconnecting member and the second output member.

According to other aspects of this disclosure, the torque vectoring system may further comprise a third planetary gear set having a third carrier member fixedly joined for common rotation with the interconnecting member, a third sun gear fixedly joined to a torque input member.

For a given first rate of rotation, the input member and the interconnecting member have a second rate of rotation, the first output member has a third rate of rotation, and the second output member has a fourth rate of rotation. The second rate of rotation is less than the first rate of rotation, and the second rate of rotation is greater than one of the third rate of rotation and the fourth rate of rotation. The third planetary gear set may be coaxial to the interconnecting member.

The above aspects of this disclosure and other aspects will be described below with reference to the attached drawings.

### BRIEF DESCRIPTION OF THE DRAWINGS

FIG. 1 is a schematic diagram illustrating an example of an electrified vehicle.

FIG. 2 is a diagrammatic representation of an electric rear axle drive that includes a vectoring system that uses grounding clutches engaging left or right planetary gear sets to reduce the torque output of one of the two planetary gear sets.

FIG. 3 is a diagrammatic view of the controller, input sensors and hydraulic system used to control the vectoring motor.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

Various features illustrated and described with reference to any one of the figures may be combined with features illustrated in one or more of the other figures to produce embodiments that are not explicitly illustrated or described. The combinations of features illustrated provide representative embodiments for typical applications. Various combinations and modifications of the features consistent with the teachings of this disclosure could be used in particular applications or implementations.

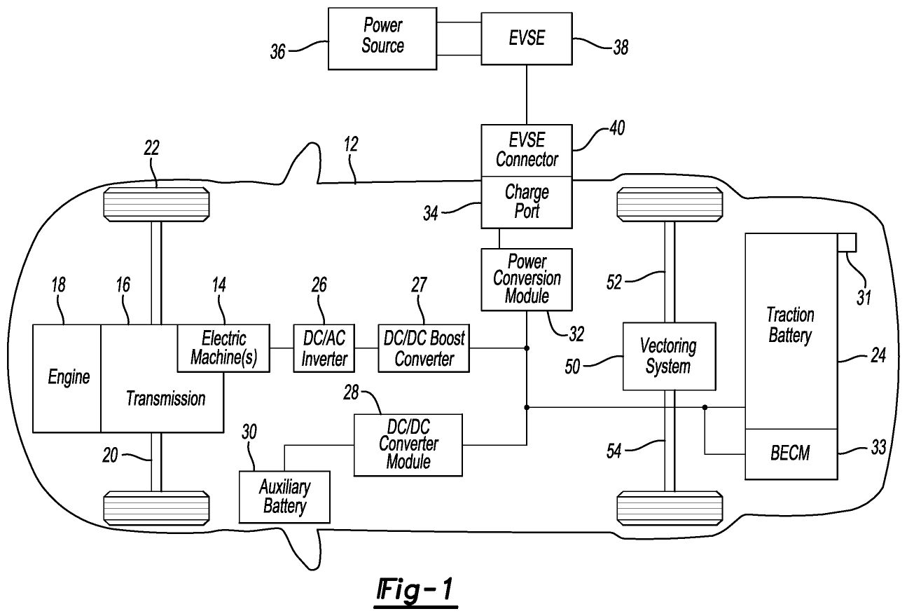

FIG. 1 illustrates a schematic diagram illustrating an example of an electrified vehicle 12. In this example, the electrified vehicle is a plug-in electric vehicle 12, however, the vectoring system disclosed herein is not limited to such vehicles and may be used on other types of electric vehicles or with an internal combustion engine vehicle. The vehicle 12 may include one or more electric machines 14 mechanically connected to a hybrid transmission 16. Each of the electric machines 14 may be capable of operating as a motor or a generator. In addition, the hybrid transmission 16 is mechanically connected to an engine 18. The hybrid transmission 16 is also mechanically connected to a drive shaft 20 that is mechanically connected to wheels 22. The electric machines 14 may provide propulsion and deceleration capability when the engine 18 is turned on or off. The electric machines 14 may also operate as generators and provide fuel economy benefits by recovering energy that would normally be lost as heat in the friction braking system. The electric machines 14 may also provide reduced pollutant emissions since the vehicle 12 may be operated in electric mode under certain conditions.

A traction battery 24 stores energy that may be used by the electric machines 14. The traction battery 24 typically provides a high voltage DC output from one or more battery cell arrays, sometimes referred to as battery cell stacks, within the traction battery 24. The battery cell arrays may include one or more battery cells. The traction battery 24 is electrically connected to one or more power electronics modules 26 through one or more contactors (not shown). The one or more contactors may isolate the traction battery 24 from other components when opened and may connect the traction battery 24 to other components when closed. The DC/AC inverter 26 is also electrically connected to the electric machines 14 and provides an ability to bi-directionally transfer electrical energy between the traction battery 24 and the electric machines 14. For example, a typical traction battery 24 may provide a DC voltage while the electric machines 14 may require a three-phase AC voltage to function. The DC/AC inverter 26 may convert the DC voltage to a three-phase AC voltage as required by the electric machines 14. In a regenerative mode, the DC/AC inverter 26 may convert the three-phase AC voltage from the electric machines 14 acting as generators to the DC voltage required by the traction battery 24. The inductor can also be applied to a DC/DC boost converter 27 that is optional but may be used to boost the traction battery voltage to a higher voltage level. For a pure electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle loads. Other high-voltage loads, such as compressors and electric heaters, may be connected directly to the high-voltage without the use of a DC/DC converter module 28. The DC/DC power converter module may function as a boost converter capable of providing multiple levels of inductive output for either plug-in or hybrid electric vehicles. In a typical vehicle, the low-voltage systems are electrically connected to an auxiliary battery 30 (e.g., a twelve-volt battery).

A battery electrical control module (BECM) 33 may be in communication with the traction battery 24. The BECM 33 may act as a controller for the traction battery 24 and may also include an electronic monitoring system that manages temperature and charge state of each battery cell of the traction battery 24. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36 such as an electrical outlet. The external power source 36 may be electrically connected to an electric vehicle supply equipment (EVSE) 38. The EVSE 38 may provide circuitry and controls to regulate and manage the transfer of electrical energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The charge connector 40 may have pins that mate with corresponding recesses of the charge port 34.

A vectoring system 50 is provided between a right axle shaft 52 and a left axle shaft 54. The vectoring system 50 is controlled by a controller that receives data indicative of a turn radius, data indicative of wheel slippage on surfaces having a low coefficient of friction such as ice, and data indicative of the rotational speed of the right and left axle shafts. The vectoring system 50 may be used on both axles of a battery electric vehicle, either the front or rear axle of a hybrid system or and internal combustion engine system.

The various components discussed above may have one or more associated controllers to control and monitor the operation of the components. The controllers may communicate via a serial bus (e.g., a controller area network (CAN)) or via discrete conductors.

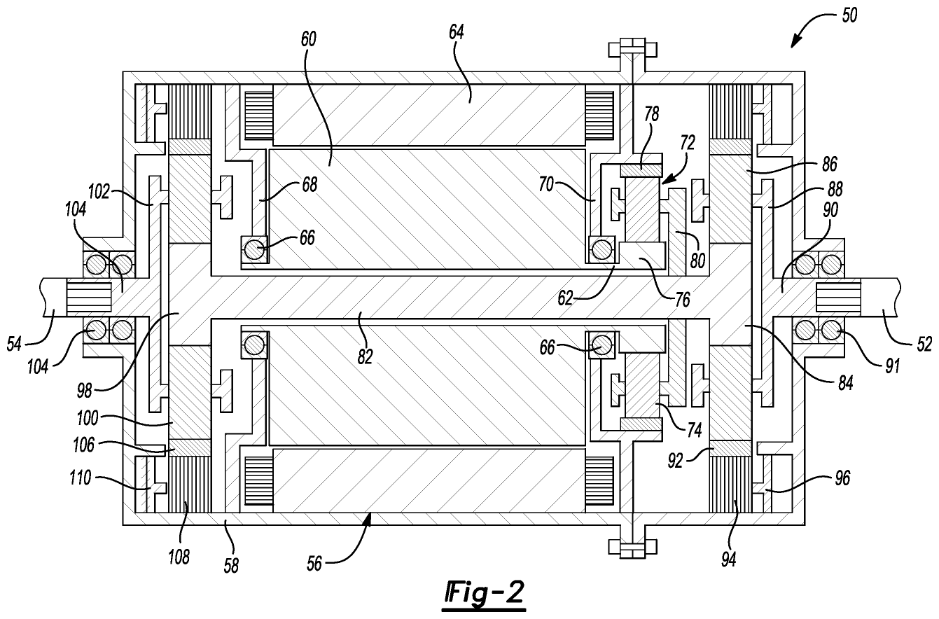

Referring to FIG. 2, the vectoring system 50 provides torque to a right axle shaft 52 and a left axle shaft 54. A motor 56 is disposed within a case 58 of the vectoring system 50.

The motor 56 includes a rotor 60 having a tubular output shaft 62. A stator 64 is disposed around the rotor 60 and rotates the rotor 60 to propel the vehicle 12 (shown in FIG. 1). The tubular output shaft 62 is journaled in a set of rotor bearings 66 seated in a left partition 68 and a right partition 70 of the case 58. A driveshaft (not shown) may be used as a torque input apparatus instead of the motor 56. Such a driveshaft may be connected to a bevel gear system that drives a tubular output shaft in which a linking shaft may be received.

A torque multiplier planetary gear set 72 increases the torque and reduces the speed of the output of the gear set 72. The torque multiplier planetary gear set 72 includes a plurality of planetary gears 74 that are driven by a sun gear 76. The sun gear 76 may be integral with the tubular output shaft 62 or may be affixed to the tubular output shaft 62. A ring gear 78 is grounded to the case 58 through the partition 70. The planetary gears 74 are pivotably attached to a carrier 80 that is connected to a linking shaft 82. Torque from the sun gear 76 is transferred to the planetary gears 74, to the carrier 80, and then to the linking shaft 82.

A right sun gear 84 of a first planetary gear set is attached or integral with the linking shaft 82 that engages a plurality of planetary gears 86 that are pivotably attached to a carrier 88. Carrier 88 is attached to or integral with a right-side stub shaft 90. The right-side stub shaft 90 is journaled within the case 58 by axle bearings 91. A ring gear 92 is normally locked by a grounding clutch 94 when the vehicle is traveling in a straight line and no vectoring is required. A hydraulic actuator 96 is provided adjacent the grounding clutch 94 to lock-up the grounding clutch 94. Instead of a hydraulic actuator, a system using magnetic rheologic fluid, or a reversible e-drive motor may be used to actuate the clutches with a ball ramp. The actuator 96 partially releases the grounding clutch 94 allowing the ring gear 92 to slip to a limited extent thereby reducing the torque provided to the right axle shaft 52 when turning right.

As with the right side of the vectoring system 50, left sun gear 98 of a second planetary gear set is provided on the linking shaft 82 that engages a plurality of planetary gears 100 that are pivotably attached to a carrier 102. Carrier 102 is provided with a left-side stub shaft 104. The left-side stub shaft 104 is journaled within the case 58 by axle bearings 105. A ring gear 106 is normally locked by a grounding clutch 108 when the vehicle is traveling in a straight line and no vectoring is required. A hydraulic actuator 110 is provided adjacent the grounding clutch 108 to lock-up the grounding clutch 108. The actuator 110 partially releases the grounding clutch 108 allowing the ring gear 106 to slip to a limited extent thereby reducing the torque provided to the left axle shaft 54 when turning left.

Instead of a grounding clutch, a brake, a static clutch, or a magnetic particle clutch may be used to lock up or allow the ring gears 92, 106 to slip.

A vehicle operating on a surface with a low coefficient of friction, such as an icy surface or a rain slick surface, can compensate for wheel slippage with the disclosed vectoring system 50. For example, if one wheel contacts an icy surface, a wheel speed sensor may communicate with a controller to reduce the torque supplied to that wheel by allowing its associated ring gear to slip. It may also be necessary to allow some slippage to accommodate slight differences in wheel diameter.

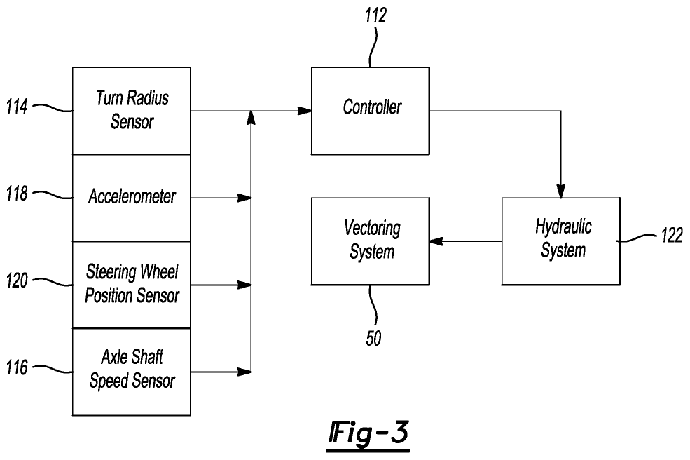

Referring to FIG. 3, a controller 112 receives data from turn radius sensor 114 and at least one axle speed sensor 116. Other sensors such as an accelerometer 118, a steering wheel position sensor 120, or the data bus of the vehicle may provide data to the controller 112. During a turn, the controller 112 actuates a hydraulic system 122 connected to the vectoring system 50 and, more specifically, to one of the first and second grounding clutches 94, 108 (shown in FIG. 2) to partially release the ring gear 92, 106 (shown in FIG. 2) of a selected one of the planetary gear sets (shown in FIG. 2) and reduce torque output provided to a planet carrier 88, 102 (shown in FIG. 2) of the planet gears 86, 100 (shown in FIG. 2) of the selected one of the planetary gear sets.

The vectoring system 50 may be used with a regeneration system by allowing the axle shafts to drive the motor 56 in reverse to energy to the system's batteries. The vectoring system 50 may also be used to allow the vehicle to coast by disconnecting the motor 56 from the axles. In some systems, such as hybrid systems, the top speed of a vehicle may be limited by the motor speed. The disclosed vectoring system 50 may be used to disconnect the axle shafts and allow the vehicle to travel at a higher speed.

The vectoring system 50 may be a modular system thereby allowing the vectoring system 50 to function as a component of a super-positioning system.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A vehicle comprising:
a vectoring motor disposed in a case and connected to an axle including a right axle shaft and a left axle shaft for propelling the vehicle, wherein the vectoring motor includes a rotor and a tubular output shaft that defines a central opening;
a torque multiplying gear set receives torque from tubular output shaft of the vectoring motor and transfers torque to a linking shaft that extends through the central opening;
a first planetary gear set and second planetary gear set including first sun gear and second sun gears that are connected to first and second ends of the linking shaft, wherein the linking shaft provides torque to the first and second sun gears of the first and second planetary gear sets, the first and second planetary gear sets each include a plurality of planetary gears connected to a planetary gear carrier and connected to first and second ring gears of the first and second planetary gear sets, wherein the planetary gear carriers are connected to the right and left axle shafts; and
first and second grounding clutches normally locking the first and second ring gears to the case of the vectoring motor, the grounding clutches being selectively and partially released to allow the ring gear of one of the first and second planetary gear sets to slip relative to the case thereby reducing a torque output provided to the carrier of one of the first and second planetary gears and to one of the right and left axle shafts.

2. The vehicle of claim 1 wherein torque is provided equally to both right and left axle shafts when the vehicle is moving in a straight line with both ring gears locked, wherein torque provided to the right axle shaft is reduced by the first grounding clutch partially releasing the first ring gear and allowing the first ring gear to slip when the vehicle turns to the right, and wherein torque provided to the left axle shaft is reduced by the second grounding clutch partially releasing the second ring gear and allowing the second ring gear to slip when the vehicle turns to the left.

3. The vehicle of claim 1 further comprising:
a controller that receives data from a turning radius sensor and at least one axle speed sensor, wherein during a turn, the controller actuates a hydraulic system connected to one of the first and second grounding clutches to partially release the ring gear of a selected one of the planetary gear sets and reduce torque output provided to a planet carrier of the planet gears of the selected one of the planetary gear sets.

4. The vehicle of claim 1 wherein torque provided to the right axle shaft is reduced by the first grounding clutch partially releasing the first ring gear and allowing the first ring gear to slip when a right wheel slips on a surface with a low coefficient of friction, and wherein torque provided to the left axle shaft is reduced by the second grounding clutch partially releasing the second ring gear and allowing the second ring gear to slip when a left wheel slips on a surface with a low coefficient of friction.

5. The vehicle of claim 4 further comprising:
a controller that receives data from at least one axle speed sensor, wherein the controller actuates a hydraulic system of one of the first and second grounding clutches to partially release the ring gear of a selected one of the planetary gear sets and reduce torque output provided to a planet carrier of the planet gears of the selected one of the planetary gear sets.

6. The vehicle of claim 1 wherein the torque multiplying gear set is a speed reducing and torque increasing planetary gear set.

7. The vehicle of claim 1 further comprising:
a hydraulic actuator that actuates the grounding clutch to selectively and partially release the ring gear to allow the ring gear to slip relative to the case.

8. A vectoring drive for a vehicle comprising:
a case;
a motor disposed in the case and including a rotor, a tubular output shaft defining a central opening, and a stator disposed around an outer diameter of the rotor;
a linking shaft extends through the central opening;
a torque multiplying gear set connected to the tubular output shaft provides torque to the linking shaft;
a first planetary gear set on a right end of the linking shaft has a first sun gear that receives torque through the linking shaft from the torque multiplying gear set;
a second planetary gear set on a left end of the linking shaft has a second sun gear that receives torque through the linking shaft from the torque multiplying gear set;
a first grounding clutch normally locks a first ring gear of the first planetary gear set to the case;
a second grounding clutch normally locks a second ring gear of the second planetary gear set to the case;
a right axle shaft operatively connected to a first carrier of a first plurality of planet gears of the first planetary gear set; and
a left axle shaft operatively connected to a first carrier of a second plurality of planet gears of the second planetary gear set, wherein torque is provided equally to both right and left axle shafts with both ring gears locked, wherein torque provided to the right axle shaft is reduced by the first grounding clutch partially releasing the first ring gear and selectively allowing the first ring gear to slip, and wherein torque provided to the left axle shaft is reduced by the second grounding clutch partially releasing the second ring gear and selectively allowing the second ring gear to slip.

9. The vehicle of claim 8 further comprising:
a first hydraulic actuator that engages the first grounding clutch to selectively and partially release the first ring gear to allow the first ring gear to slip relative to the case; and
a second hydraulic actuator that engages the second grounding clutch to selectively and partially release the second ring gear to allow the second ring gear to slip relative to the case.

10. The vehicle of claim 8 wherein torque is provided equally to both right and left axle shafts when the vehicle is moving in a straight line with both ring gears locked, wherein torque provided to the right axle shaft is reduced by the first grounding clutch partially releasing the first ring gear and allowing the first ring gear to slip when the vehicle turns to the right, and wherein torque provided to the left axle shaft is reduced by the second grounding clutch partially releasing the second ring gear and allowing the second ring gear to slip when the vehicle turns to the left.

11. The vehicle of claim 10 further comprising:
a controller that receives data from turning radius sensor and at least one axle speed sensor, wherein during a turn, the controller actuates a hydraulic system connected to one of the first and second grounding clutches to partially release the ring gear of a selected one of the planetary gear sets and reduce torque output provided to a planet carrier of the planet gears of the selected one of the planetary gear sets.

12. The vehicle of claim 8 wherein torque provided to the right axle shaft is reduced by the first grounding clutch partially releasing the first ring gear and allowing the first ring gear to slip when a right wheel slips on a surface with a low coefficient of friction, and wherein torque provided to the left axle shaft is reduced by the second grounding clutch partially releasing the second ring gear and allowing the second ring gear to slip when a left wheel slips on a surface with a low coefficient of friction.

13. The vehicle of claim 12 further comprising:
a controller that receives data from at least one axle speed sensor, wherein the controller actuates a hydraulic system of one of the first and second grounding clutches to partially release the ring gear of a selected one of the planetary gear sets and reduce torque output provided to a planet carrier of the planet gears of the selected one of the planetary gear sets.

14. A torque vectoring system comprising:
a housing with a first end and a second end disposed opposite the first end;
an interconnecting member rotationally supported by the housing;
a first planetary gear set and a second planetary gear set disposed adjacent the first end and the second end of the housing, respectively;
a first sun gear and a second sun gear of the first and the second planetary gear sets, respectively, are each fixedly joined for common rotation to the interconnecting member;
a first output member and a second output member, and wherein the first output member is fixedly joined for common rotation to a first carrier member of the first planetary gear set, and the second output member is fixedly joined for common rotation to a second carrier member of the second planetary gear set;
a first clutch selectively connects a first ring gear of the first planetary gear set to the housing; and
a second clutch selectively connects a second ring gear of the second planetary gear set to the housing, wherein partial release of the first clutch reduces a first torque ratio between the interconnecting member and the first output member and partial release of the second clutch reduces a second torque ratio between the interconnecting member and the second output member.

15. The torque vectoring system of claim 14, further comprising
a third planetary gear set having a third carrier member fixedly joined for common rotation with the interconnecting member, and a third sun gear fixedly joined to a torque input member.

16. The torque vectoring system of claim 15, wherein for a given first rate of rotation the torque of the input member, the interconnecting member has a second rate of rotation, the first output member has a third rate of rotation, and the second output member has a fourth rate of rotation, the second rate of rotation is less than the first rate of rotation, and the second rate of rotation is greater than one of the third rate of rotation and the fourth rate of rotation.

17. The torque vectoring system of claim 15, wherein the third planetary gear set is coaxial with the interconnecting member.
